(19) United States
(12) Patent Application Publication
(10) Pub. No.: US 2013/0341899 A1
(43) Pub. Date: Dec. 26, 2013

(54) ACOUSTIC SPLASH SHIELD

(71) Applicant: Robert Sean Boyd, Howell, MI (US)

(72) Inventor: Robert Sean Boyd, Howell, MI (US)

(73) Assignee: Toyota Motor Engineering & Manufacturing North America, Inc., Erlanger, KY (US)

(21) Appl. No.: 13/533,204

(22) Filed: Jun. 26, 2012

(51) Int. Cl. E04B 1/82; B62D 25/18

(52) U.S. Cl. 280/850; 181/292

(57) ABSTRACT

An acoustic splash shield that combines sound damping and sound absorption is provided. The splash shield can have a first solid thermoplastic layer, an optional second porous layer extending across the first solid layer and a third hollow-shaped and/or corrugated-shaped thermoplastic layer extending across the second porous layer. The first, optional second, and third layers are operatively arranged to form an integral component with the second porous layer sandwiched between the first and third layers in order to provide a sound damping and sound absorbing splash shield having a pair of non-porous outer layers. The third hollow-shape and/or corrugated-shaped thermoplastic layer forms a plurality of hollow rectangular-shaped cavities against the first solid thermoplastic layer and the cavities are shaped in order to provide a plurality of hollow sound absorbing cavities that absorb sound wave frequencies within a desired range.

### FIELD OF THE INVENTION

The present invention is related to a splash shield for a motor vehicle, and in particular, to a splash shield that integrates sound damping and sound absorption into a single component

### BACKGROUND OF THE INVENTION

The use of a splash shield proximate to a tire of a motor vehicle, on an underside of the motor vehicle, and the like is known. Such splash shields prevent water, dirt, and the like from coming into contact with the motor vehicle engine, motor vehicle white body, etc.

In some instances, the splash shield can be made from a polymer panel and may or may not have an additional porous and/or fiber containing layer for the purpose of absorbing tire noise, air/road noise, and/or engine noise during operation of the motor vehicle. Such dual layer splash yields can decrease the amount or level of noise noticeable or heard by an individual operating or traveling within the vehicle. However, heretofor splash shields have relied on added sound absorbing fiber pads and have not taken advantage of a one-piece integrated absorbing and damping feature. Therefore, a simple and cost effective splash shield that reduces noise within a passenger compartment of a motor vehicle by using a combination of sound damping and sound absorption would be desirable.

### SUMMARY OF THE INVENTION

An acoustic splash shield that combines sound damping and sound absorption is provided. The splash shield can have a first solid thermoplastic layer, an optional second porous layer extending across the first solid layer and a third hollow shaped thermoplastic layer extending across the second porous layer. In some instances the second porous layer is not required and only the first solid layer and the third hollow shaped layer are present. The third layer is comprised of hollow shapes that absorb sound. The shapes can be of any configuration that is desirable for tool design, packaging space or appearance. For example and for illustrative purposes only, the shapes can be cubical, elongated channels, semispherical, irregular arcuate, and the like. Stated differently, the hollow cavities can have any shaped that can be vacuumed formed into a thermoplastic layer.

The first, optional second, and third layers can be operatively arranged to form an integral component with the second porous layer sandwiched between the first and third layers in order to provide a sound damping and sound absorbing splash shield having a pair of non-porous outer layers. The third hollow-shaped thermoplastic layer forms a plurality of hollow cavities against the first solid layer and the cavities are shaped or dimensioned in order to provide a plurality of hollow sound absorbing cavities that absorb sound acoustic frequencies within a desired range. Stated differently, each of the plurality of hollow cavities can have a width, length, height and volume and the width, length, height and volume are determined and set as a function of a range of sound wave frequencies that are desired to be absorbed by the acoustic splash shield.

The acoustic splash shield can be a fender liner located within a fender well of a motor vehicle and the plurality of hollow shaped cavities have a width, length, height and volume specifically set to absorb sound wave frequencies between 100 to 10,000 Hertz. In addition, the plurality of hollow-shaped cavities can be any hollow shape, or in the alternative, hollow elongated channels or grooves such as those provided by a corrugated type panel.

A process for absorbing noise occurring during operation of a motor vehicle is also provided, the process including providing the motor vehicle with an acoustic splash shield in the form of a fender liner. The acoustic splash shield can have a first layer in the form of a solid thermoplastic panel, an optional second layer in the form of a porous or fibrous panel and a third layer in the form of a panel comprised of a plurality of hollow shaped cavities of any desirable shape. The first, optional second, and third layers are arranged to form art integral component with the second porous layer sandwiched between the first and third layers in order to provide an acoustic damper and absorber having a pair of non-porous outer layers.

The acoustic splash shield in the form of the fender liner is attached within a fender well of the motor vehicle and the vehicle is operated along the road such that tires of the vehicle provide a tire noise having a range frequency between 100 to 10000 Hertz. The plurality of hollow-shaped cavities have a size and/or volume to absorb at least part of the tire noise and thus decrease an amount of tire noise experienced by an individual and/or a sensor located within a passenger compartment of the vehicle.

### BRIEF DESCRIPTION OF THE DRAWINGS

FIG. 1 is a schematic illustration of a motor vehicle having an acoustic splash shield in the form of a fender liner;

FIG. 2 is a prospective view of a fender liner according to an embodiment of the present invention;

FIG. 3 is an end cross-sectional view of the region labeled FIG. 3 in FIG. 2;

FIG. 4 is a perspective view of waffle-shaped layer of an acoustic splash shield according to an embodiment t of the present invention; and

FIG. 5 is a perspective view of a corrugated-shaped layer of an acoustic splash shield according to an embodiment of the present invention.

### DETAILED DESCRIPTION OF THE PREFERRED EMBODIMENTS

An acoustic splash shield that combines sound damping and sound absorption to reduce noise heard or noticed within a passenger compartment of a motor vehicle is provided. As such, the present invention has use as a component for a motor vehicle.

The acoustic splash shield can have a plurality of hollow-shaped and/or corrugated-shaped cavities that can absorb sound. The plurality of hollow-shaped and/or corrugated-shaped cavities can have a width, length, height and/or volume that is designed and set to absorb sound waves having a specific frequency or range of frequencies. Although not required, a porous or fibrous layer can be included and sandwiched between two outer non-porous layers with one of the outer non-porous layers having the hollow-shaped and/or corrugated-shaped cavities. In addition, the porous or fibrous layer sandwiched between the two outer non-porous layers can be in the form of an integral panel that can be attached at a desired location of a motor vehicle and used as acoustic splash shield.

In some instances, the acoustic splash shield can have a first thermoplastic layer in the form of a generally planer, smooth and/or solid panel and a second porous or fibrous layer extending across the first layer. In addition, a third thermoplastic layer of hollow cavities can extend across the second porous or fibrous layer such that the porous or fibrous layer is sandwiched between the first and third layers. It is appreciated that the first thermoplastic layer can have contours, bends, etc., but the first layer is void of the hollow-shaped and/or corrugated-shaped cavities of the third thermoplastic layer. The first and third layers can be sealed along an outer edge of each layer such that a “water-proof” acoustic splash shield is provided and water, moisture, dirt, etc., does not come into contact with the second porous or fibrous layer.

The plurality of hollow cavities can provide or serve as a plurality of sound absorbing resonators that absorb a desired sound wave frequency or a desired range of sound wave frequencies. For example, the acoustic splash shield can be part of a fender liner that is located proximate to a motor vehicle tire as is known to those skilled in the art. In addition, the acoustic splash shield in the form of the fender liner can absorb noise having a frequency range between 100 to 10,000 Hertz.

In the alternative, the acoustic splash shield can be part of an engine noise absorbing panel located between an engine and a passenger compartment of the motor vehicle and absorbs at least part of engine noise having a frequency range between 100 to 10,000 Hertz. In another alternative, the acoustic splash shield can be an under-body splash shield that absorbs air/wheel noise having a sound wave frequency of 100 to 10,000 Hertz.

The first solid thermoplastic layer and the third hollow-shaped thermoplastic layer can be made from at least one of a low density polyethylene, a high density polyethylene, a polypropylene, a polyurethane and nylon and the second porous or fibrous layer can be made from at least one of polyurethane foam, a cotton fiber, a polyester fiber, polypropylene fiber, cardboard and fiberglass. The acoustic splash shield can be made using any technique or process known to those skilled in the art, illustratively including a process that combines compression and vacuum molding of polymer panels.

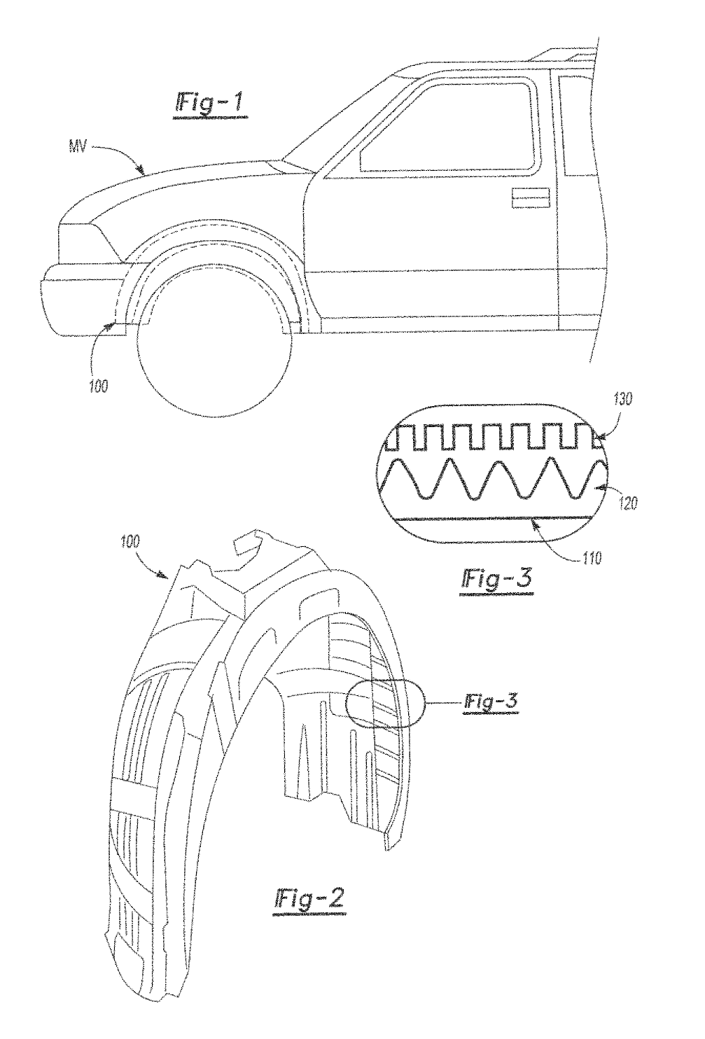

Turning now to FIGS. 1 and 2, a motor vehicle MV can have an acoustic splash shield 100 according to an embodiment of the present invention, the acoustic splash shield 100 being in the form of a fender liner. In the alternative, or in addition to, the acoustic splash shield can be in the form of an under-body panel (not shown) an engine shield panel and the like. In addition, the acoustic splash shield 100 can have a first layer on 110, an optional second layer 120, and a third layer 130 as illustrated in FIG. 3. Stated differently, the second layer 120 is not required.

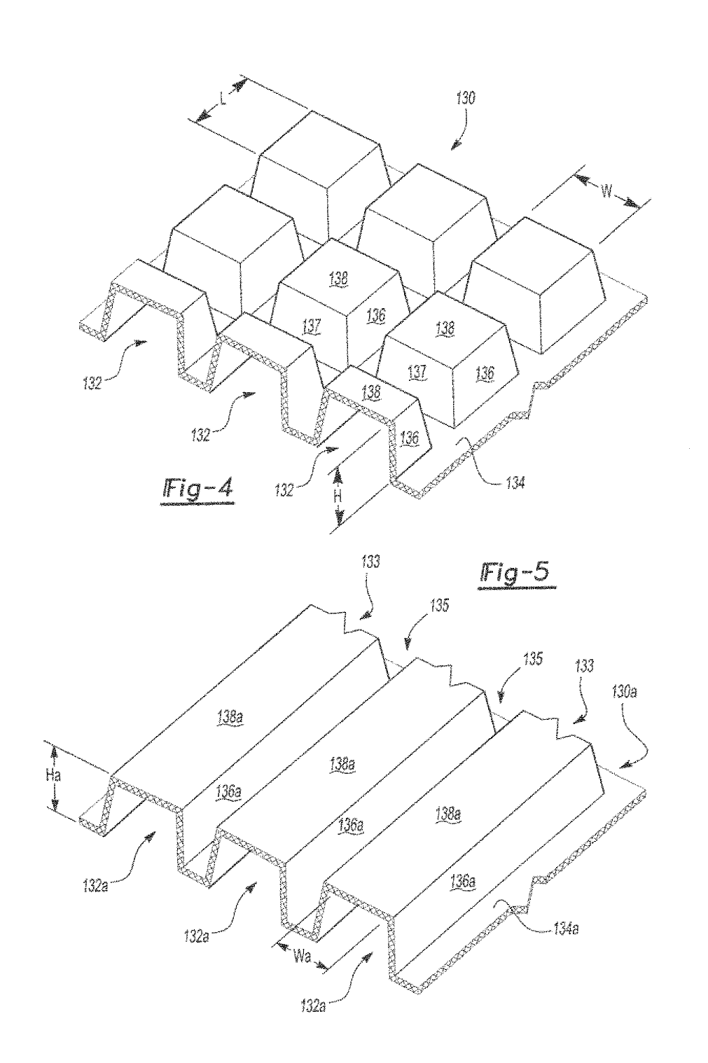

The first layer 110 can be a thermoplastic panel that is generated plainer or smooth as opposed to the third layer 130 that can include hollow shapes or cavities of any size, shape or volume. For example and for illustrative purposes only, cube-shaped cavities 132 and elongated channel-shaped cavities 132a are shown in FIGS. 4 and 5, respectively. In between the first layer 110 and the third layer 130 can be the optional second layer 120 which is a fibrous or porous material. In some instances, the first layer 110 can be a thermoplastic material with a thickness of between 0.5 to 1.0 millimeters, the second layer can be made from a porous or fibrous material and have a thickness between 1.0 to 1.0 millimeters and the third layer can be waffle-shaped or corrugated-shaped and have a thickness between 0.5 to 1.0 millimeters.

As shown in FIGS. 3 and 4, the hollow-shaped third layer 130 can afford for the plurality of cavities 132 that have a width W, a length L, height H and volume V. The third layer 130 can have a base 134 with one or more sidewalls 136 and end walls 137 extending therefrom, and top walls 138 can extend from and between the sidewalls 136 and end walls 137 to form an enclosure or cavity 132. In addition, the plurality of cavities of 132 can be periodic, or in the alternative, not be of the same size throughout the entire third layer 130. In some instances, the cavities 132 form hollow cubes, however, this is not required. In addition, the width W, the length L, height H and Volume V can be set or designed as a function of a sound frequency or a range of sound frequencies that are desired to be absorbed.

Not being bound by theory, an air mass in one of the cavities 132 can be excited by a sound wave frequency relative to the cavity size. As the structure containing cavities 132 is excited, the air trapped inside the cavities acts as a Mass-spring damping system. A Mass-spring damping system attenuates the acoustic energy by means of converting the mechanical energy into thermal energy. There are multiple mechanisms by which this energy conversion occurs. These mechanisms include interface friction, fluid viscosity, turbulence, acoustic radiation, eddy currents and mechanical hysteresis (also called internal friction or mechanical damping). In addition, the panel itself can have a mechanical stiffness and resonates to dissipate sound in a same and/or different manner as each hollow cavity.

The primary effects of increased panel damping are (1) reduction of vibration amplitudes at resonance, (2) more rapid decay of free vibrations, (3) attenuation of structure-borne waves propagating along the panel and (4) increased sound isolation(transmission loss) of the panel above its critical (coincidence) frequency. All of these effects are generally beneficial from the standpoint of noise and vibration control.

It is appreciated that a given cavity opening, length and volume theoretically results in absorption of a particular frequency. However, the combination of the third layer 130 with the second porous or fibrous layer 120 can provide for a range of cavity sizes, openings and the like. In addition, the third layer 130 can have a range of cavity sizes in order to absorb a range of sound wave frequencies.

Referring now to FIG. 5, another embodiment of a third layer is shown by a corrugated-shaped third layer 130a. The third 130a has a plurality of alternating ridges 133 and valleys 135 formed by sidewalls 136a extending from a base 134a and top walls 138a extending from and between two adjacent sidewalls 136a. This alternating structure provides the plurality of cavities 132a that have a width Wₐ and a height Hₐ. Not being bound by theory, and analogous to the hollow-shaped third layer 130, the corrugated-shaped layer 130a can have cavities 132a with dimensions that absorb a sound a sound wave frequency or a range of sound wave frequencies.

The acoustic splash shield can be manufactured by preheating the first layer 110 and/or the third layer 130, 130a, e.g. in an infra-red oven, and using a two-sided tool in a molding apparatus that utilizes both compression and vacuum molding. The two-sided tool can use compression to mold the composite panel and provide its overall shape. In addition, and for illustrative purposes only, one side of the two-sided tool can draw a vacuum on the third layer 130, 130a to create the waffle-shaped and/or corrugated-shaped structure. The second layer 120 can be sandwiched between the first layer 110 the third layer 130, 130(a) to provide internal sound damping and to keep the first layer 110 and the third layer 130, 130(a) separated during the heating and molding process.

It is appreciated that trimming of such acoustic splash shield to obtain a final shape can be accomplished within the tool of the molding process by means of pinch trimming. Such a process can eliminate the need to purchase separate trimming dyes or to use water-jet trimming. As such, a one-step molding and trimming process can be used to produce a three-layered panel that can improve the acoustics of a passenger compartment for a motor vehicle while being protective against water, ice, snow, dirt and the like.

Based on the above teachings, it is to be understood that various modification can be readily made to the embodiments described herein without departing from the scope and spirit of the invention. Accordingly, it is understood that the invention is not limited to this specific illustrated embodiments but by the scope of the claims.

I claim:

1. An acoustic splash shield comprising:
a solid thermoplastic layer; and
a hollow-shaped thermoplastic layer, said solid thermoplastic layer and said hollow-shaped thermoplastic layer operatively arranged to form an integral component and provide an acoustic absorber having a pair of non-porous outer layers.

2. The acoustic splash shield of claim 1, further comprising a porous layer extending across said solid thermoplastic layer, said solid thermoplastic layer, porous layer and hollow-shaped thermoplastic layer operatively arranged to form said integral component and provide said acoustic absorber having a porous layer sandwiched between said pair of non-porous outer layers.

3. The acoustic splash shield of claim 2, wherein said hollow-shaped thermoplastic layer forms a plurality of hollow rectangular-shaped cavities against said solid thermoplastic layer.

4. The acoustic splash shield of claim 2, wherein said plurality of hollow cavities against said porous layer absorb sound by means of damping.

5. The acoustic splash shield of claim 4, wherein each of said plurality of hollow cavities have a width, length, height, and volume, said width, length, height and volume set as a function of a range of sound wave frequencies.

6. The acoustic splash shield of claim 5, wherein said range of sound wave frequencies is between 100 to 10,000 Hertz.

7. The acoustic splash shield of claim 6, wherein said plurality of hollow cavities are hollow cubes.

8. The acoustic splash shield of claim 1, wherein said solid thermoplastic layer and said hollow-shaped thermoplastic layer are made from at least one of low density polyethylene, high density polyethylene, polypropylene, polyurethane and nylon.

9. The acoustic splash shield of claim 2, wherein said porous layer is made from at least one of polyurethane foam, cotton fiber, polyester fiber, polypropylene fiber, cardboard and fiberglass.

10. The acoustic splash shield of claim 2, wherein said integral component is a motor vehicle fender liner.

11. The acoustic splash shield of claim 10, wherein said motor vehicle fender liner is front rear wheel fender liner.

12. An acoustic splash shield for a motor vehicle, said acoustic splash shield comprising;
first layer in the form of a solid thermoplastic panel;
a second layer in the form of a porous panel, said second layer extending across said first layer; and
a third layer in the form of a hollow-shaped thermoplastic panel having a plurality of hollow-shaped cavities;
said first, second and third layers operatively arranged to form an integral component with said second porous layer sandwiched between said first and third layers and provide an acoustic absorber having a pair of non-porous outer layers;
said integral component attached to a motor vehicle.

13. The acoustic splash shield of claim 12, wherein said plurality of hollow-shaped cavities are located against said second porous layer and form a plurality of hollow cavities.

14. The acoustic splash shield of claim 13, wherein each of said plurality of hollow cavities have a width, length, height, and volume said width, length, height, and volume being a function of a range of sound wave frequencies.

15. The acoustic splash shield of claim 14, wherein said range of sound wave frequencies is between 100 to 10,000 Hertz.

16. The acoustic splash shield of claim 15, wherein said plurality of hollow cavities are hollow shapes of any configuration that is desirable for tool design, packaging space or appearance.

17. The acoustic splash shield of claim 12, wherein said first solid thermoplastic layer and said third hollow-shaped thermoplastic layer are made from at least one of low density polyethylene, high density polyethylene, polypropylene, polyurethane and nylon.

18. The acoustic splash shield of claim 12, wherein said second porous layer is made from at least one of polyurethane foam, cotton fiber, polyester fiber, polypropylene fiber, cardboard and fiberglass.

19. The acoustic splash shield of claim 12, wherein said integral component is a front or rear wheel fender liner.

20. A process for absorbing noise occurring during operation of a motor vehicle, the process comprising:
providing a motor vehicle;
providing an acoustic splash shield in the form of a fender liner and having:
a first layer in the form of a solid thermoplastic panel;
a second layer in the form of a porous panel, said second layer extending across said first layer; and
a third layer in the form of a hollow-shaped thermoplastic a plurality of rectangular-shaped cavities;
said first, second and third layers operatively arranged to form an integral component with said second porous layer sandwiched between said first and third layers and provide an acoustic absorber having a pair of nonporous outer layers;
attaching the fender liner to the motor vehicle within a fender well; and
driving the motor vehicle along a road such that tires of the motor vehicle provide a tire noise having a frequency range between 100 to 10,000 hertz, the fender liner absorbing at least part of the tire noise and thereby preventing at least part of the tire noise from entering a passenger compartment of the motor vehicle.
